(19) United States
(12) Patent Application Publication
(10) Pub. No.: US 2020/0391823 A1
(43) Pub. Date: Dec. 17, 2020

(54) REAR WHEEL MOUNTED DRIVE MECHANISM FOR BICYCLES AND REVERSE TRIKES

(71) Applicant: Ravi Shankar Gautam, Gaya (IN)

(72) Inventor: Ravi Shankar Gautam, Gaya (IN)

(21) Appl. No.: 16/977,742

(22) PCT Filed: Mar. 3, 2019
(86) PCT No.: PCT/IN2019/050184

§ 371 Date: Sep. 2, 2020

(30) Foreign Application Priority Data
Mar. 3, 2018 (IN) 201821007903

(51) Int. Cl. B62M 11/14; F16H 1/36

(52) U.S. Cl. CPC B62M 11/145; B62K 3/00; F16H 1/36

(57) ABSTRACT

This patent discloses compact size drive mechanism for bikes and reverse trikes. Drive mechanism comprises a pair of drive assemblies mounted on the ends of the hub of the wheel. Each drive assembly comprises a special type of planetary gearbox in which plurality of planetary gears and a gear ring are arranged in such a way that gear ring can be rotated via pedal which in turn rotates planetary gears. Hub of the wheel at each end is coaxially connected to a planetary gear of the gearbox via one way ratchet ball bearing. Planetary gear on rotation rotates the wheel. Larger radius of the gear ring than planetary gears accounts for gear ratio. Drive mechanism doesn't come in contact with clothing of the rider. Specially designed rear wheel support system secures the wheel to the frame, provides reinforcement to drive assembly position and is aligned to promote forward motion.

### FIELD OF INVENTION

Compact drive mechanism for bicycle and reverse trike.

### BACKGROUND OF INVENTION

Typically bicycle consists of a frame which facilitates installation of a drive mechanism in the front part which rotates the rear using a shaft or chain drives. These bicycles are big in size which is difficult to use, particularly school going children. Even if we reduce the size, we need to reduce the size of wheels to the extent that it becomes prohibitively difficult cover long distance. We have given compact drive mechanisms for bikes and reverse trikes. It is obvious that reverse trikes are more safe and stable than bikes. More importantly, according to many research articles, reverse trikes have many mechanical advantages over conventional trikes which includes stability, traction in uphills and steerability.

### TECHNICAL PROBLEM

In conventional bicycle and reverse trikes manual force is transmitted to the rear wheel via chain drive or shaft drive using bevel-pinion gear mechanism.

In bicycle rear wheel is pedaled via pedals which are directly connected to the rear wheel hub but we don't get gear ratio.

### SUMMARY OF INVENTION

One of our objectives is to provide compact size bilateral sided drive mechanism to make maximum utilization of manual force on both sides of the bicycle. Drive mechanism consists of two force transmission mechanisms, one on each side of the bicycle.

One of our objective is to allow the ease of use provided by conventional bicycle that is drive mechanism allow the application of manual force via pedals rotation about fixed center.

Objective of this invention is also to provide force transmission mechanism with localized gear ratio and to conceal drive mechanism from the riders clothing.

In order to achieve objectives [05]-[07] drive assembly employs pivoted-slewing-bearing-epicyclic gear (a special type of planetary gear box), with a ratchet ball bearing mounted on one planetary gear, which helps it to facilitate rider to rotate the wheel by the rotation of pedals as described below.

This feature is accomplished by employing pivoted-slewing-bearing-epicyclic gear and a pedal in each drive assembly as described below.

Pivoted-slewing-bearing-epicyclic-gear is a special type of gear in which planetary gears journalled to a carrier plate and a gear ring are arranged in such a way that gear ring can be used as a point of input from manual force via pedal. Gear ring, which is pivoted axially to carrier plate, via a pivot plate, as well as pivoted peripherally, by virtue of being part of an internal toothed slewing bearing, can be rotated via a pedal, which in turn rotates planetary gears along its direction.

One planetary gear, located at rear part of drive assembly, at its center is coaxially connected to an end of the hub of the wheel via one way ratchet ball bearing.

Gear ratio is achieved by the difference in radius of outer ring gear and planetary gear of epicyclic gear. In normal configuration gear ratio is around 2.5.

Drive mechanism doesn't come in contact with clothing of the rider as all its internal parts lie between the pair of carrier plates/pivot plates.

One of our objective is to achieve the driving efficiency comparable to conventional chain driven bicycle.

This objective is achieved due to a feature which maximizes the number of tooth of gear ring gear that is used to rotate the planetary gears.

This feature is accomplished by the appropriately journaling additional gears, apart from planetary and sun gears, to the carrier plate. These additional gears are classified in two categories, one is referred in this patent as satellite gears and the other as far planet gears.

Far planetary gears, of smaller size as compared to planetary gears, are meshingly engaged with gear ring and their sole purpose is to provide additional rotatory force to planetary gears via satellite gears. Satellite gears are meshingly engaged with two adjacent planetary gears and a far planet gears. With this feature loss of manual force is further minimized and efficiency of chain driven drive mechanism is achieved without using chain.

One of our objective is to position the seat towards front half of the rear wheel as preventive measure against rearwardly tipping off of the rider. Since the drive assembly is mounted to rear wheel at its rear planetary gear center of rotation of the pedal is located on the front half of the rear wheel, thereby allowing the seat to be mounted above the front half of the wheel without causing any inconvenience during pedaling.

One of the various objectives is to provide robust wheel support system which, in addition to secure the rear wheel, should facilitate better bike kinematics. This is achieved in the form of backward slanted fork used to secure the rear wheel to the frame.

### BRIEF DESCRIPTION OF DRAWINGS

FIG. 1 Reverse trike with compact drive mechanism according to this invention.

FIG. 2 Bicycle with compact drive mechanism according to this invention.

FIG. 3 Drive mechanism

FIG. 4 and 3b Drive assembly front view and exploded back view

FIG. 6 Wheel assembly

FIG. 7 Rear wheel support system

FIG. 8 Rear wheel support system with drive support system

FIG. 9 Schematic diagram of drive assembly mechanism

FIG. 10 Impact of weight of rider on rear wheel via rear wheel support mechanism

### DESCRIPTION OF EMBODIMENTS

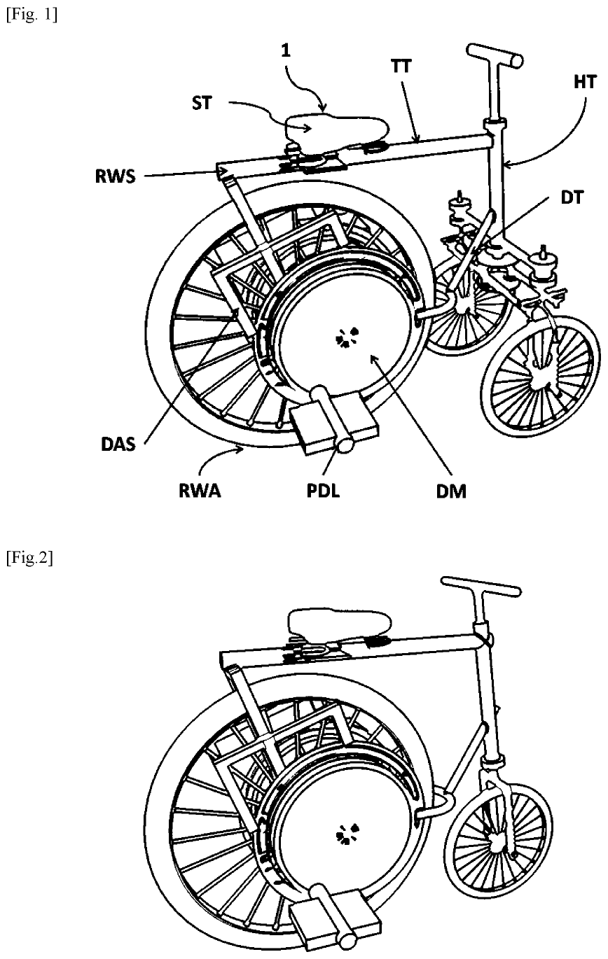

As shown in FIG. 1 reverse trike (1) in accordance with this invention, consists of drive mechanism (DM), seat (ST), top tube (TT), head tube (HT), Down tube (DT), rear wheel assembly (RWA), seat tube (STB), pedal (PDL), drive assembly support system (DAS), rear wheel support system (RWS).

As shown in [FIG. 2] bicycle with compact drive mechanism with all the parts same as reverse trike described above.

### Drive Mechanism

As shown in [FIG. 3] drive mechanism (DM) consists of pair of coupled drive assemblies (DA), pedal (PDL). Two drive assemblies complement each other.

### Drive Assembly

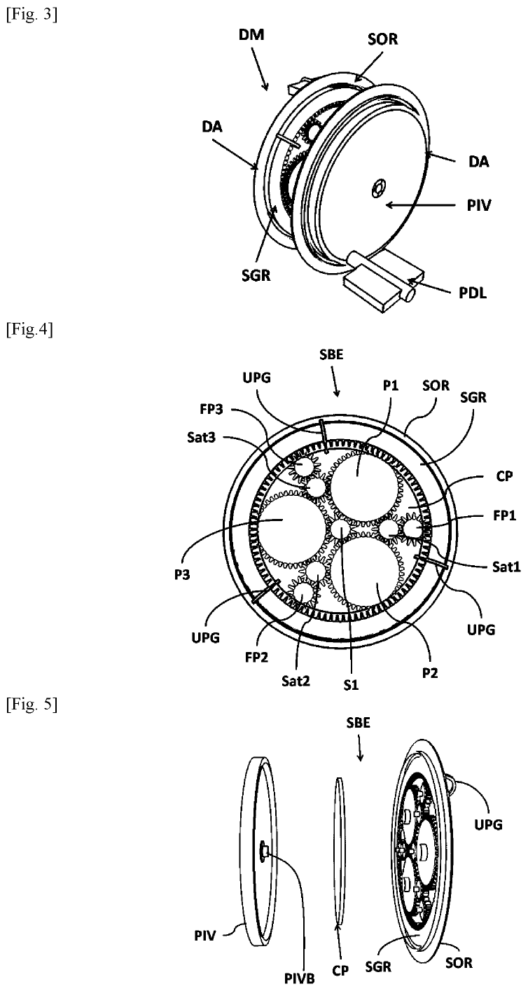

Drive assembly (DA), as shown in [FIG. 4], comprises of a special type of epicyclic gear which we refer as pivoted-slewing-bearing-epicyclic-gear (SBE) and a pedal (PDL).

### Pivoted-Slewing-Bearing-Epicyclic Gear

As shown in [FIG. 4] and [FIG. 5] pivoted-slewing-bearing-epicyclic-gear (SBE) comprises of a circular plate called as carrier plate (CP) and plurality of planetary gears (P1), (P2), (P3), a sun gear (S1), plurality of satellite gears, (Sat1), (Sat2), (Sat3) plurality of far planet gears, (FP1) (FP2) (FP3) internal-toothed slewing bearing (ISB) and U-shaped pegs (UPG), and an eared circular plate (NV).

Internal toothed slewing bearing (ISB) consist of an internal gear ring (SGR) with internal toothing coaxially mounted on external ring (SOR) and an integrated raceway system rolling elements—balls or cylindrical rollers—that are separated by spacers. In slewing bearing, internal gear ring (SGR) can rotate with outer ring (SOR) fixed along a fixed axis, whilst guaranteeing the axial and radial link between the two parts.

Outer ring (SOR) is preferably flanged.

Three planetary spur gear (P1), (P2), (P3), sun gear (S1), three satellite gears (Sat1), (Sat2), (Sat3) and three far planet gears (FP1), (FP2), (FP3) are journalled to the carrier plate (CP) in an arrangement as explained below.

Sun gear (S1) which is a spur gear is journaled to the center of the carrier plate (CP).

Planetary gears (Px) are spur gears of equal radii, and journalled to carrier plate (CP) such that each of them is meshingly engaged with sun gear (S1) and gear ring (SGR) of the slewing bearing. Centers of planetary gears form an equilateral triangle.

Each satellite gear (Satx) which is a spur gear with radius smaller than that of planetary gears is journalled to the carrier plate such that it is meshingly engaged with two adjacent planetary gears and a far planet gear.

Centers of satellite gear form an equilateral triangle.

Each far planet gear (FP1), (FP2), (FP3) which is a spur gear with radius smaller than that of planetary gears is journalled to the carrier plate such that it is meshingly engaged with gear ring of the said slewing bearing and a satellite gear.

Carrier plate (CP) at its inner side, containing sun gear (51), is attached at its periphery to the outer ring (SOR) of the said slewing bearing over-bridging gear ring (SGR) with the help of U-shaped pegs (UPG) such that slewing bearing is coaxial with Sun gear (S1).

As shown in [FIG. 5], an eared circular plate (PIV) called as pivot plate, coaxially journalled to outer side of the carrier plate via ball bearing (PIVB), is attached at its rim to the outer side of gear ring (SGR).

### Drive Assembly Input and Output

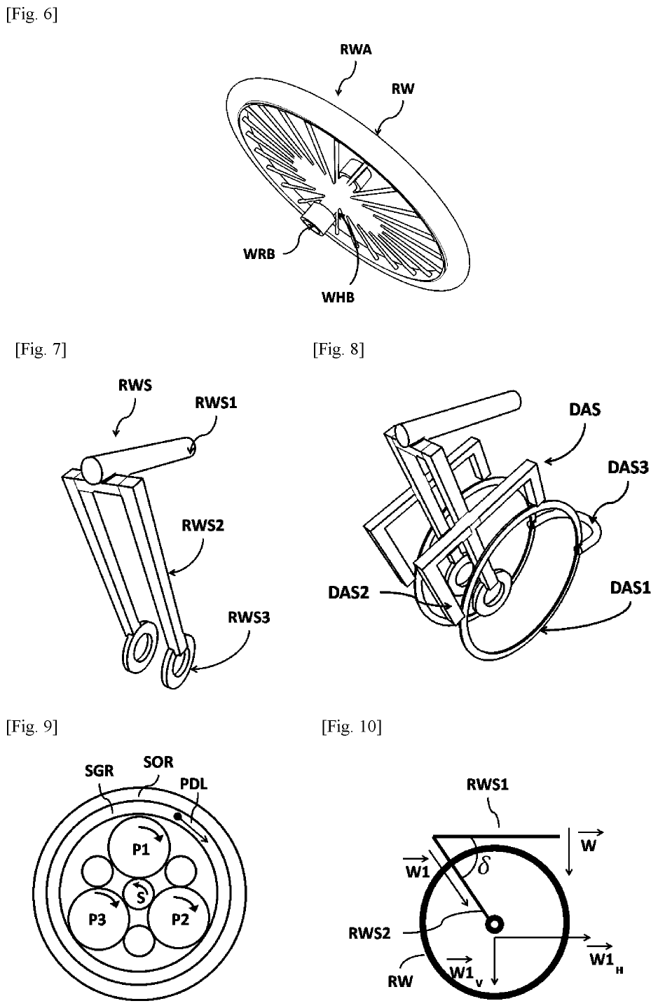

Rear planetary gear of drive assembly is coaxially connected to one end of the hub of the rear wheel (RW) via one way ratchet ball bearing (WRB), shown in [FIG. 1] and [FIG. 6].

As shown in [FIG. 3] a pedal (PDL) A pedal is attached at the periphery on the outer side of the pivot plate (PIV). Pedal in the drive mechanism on the other side of the bicycle is located on position which is the diametrically opposite to the first pedal.

Internal gear ring (SGR) act as input point and top planetary gears act as output points of drive assembly.

### Frame

Head tube (HT), as shown [FIG. 1], [FIG. 2] is a cylindrical tube on the upper front part of the frame, which coaxially holds steerer rod with the help of ball bearing.

Top tube (TT), as shown in FIG. 000 is straight cylindrical tube, located above and coplanar to the wheel, connected at its rear end to the crown of the rear wheel support system (RWS). Top tube at its front end is connected to the top of head tube.

Seat (ST) is mounted on the top tube (TT), towards front half of the rear wheel.

Down tube (DT) is a tube attached at its front to the top tube and is connected at its rear end to the fork of drive assembly support system (DAS).

### Rear Wheel Assembly

As shown in [FIG. 6], rear wheel assembly (RWA), consists of wheel (RW) on the rear part of bicycle/reverse trike with a one way ratchet ball bearing (WRB), coaxially mounted at each of the ends of its hub.

### Rear Wheel Support System

As shown in [FIG. 7] rear wheel support system (RWS) comprises a backward slanted fork (RWS2) which is attached at its crown to the rear end of rear wheel support rod (RWS2) and whose fork blades at their ends are attached to outer ring of a ball bearing (RWS3) which in turn is coaxially mounted on the hub of the rear wheel wherein rear wheel support rod (RWS1) is a straight horizontal rod which is attached at its front end to the rear end of top tube as its rearward extension extending reawardly beyond the center of the rear wheel.

### Drive Assembly Support System

As shown in [FIG. 1], [FIG. 2] and [FIG. 8] drive assembly support system (DAS) comprises
a. circular annular plate (DAS1) attached to outer side of the fork blades (RWS2) of the rear wheel support system (RWS), via rods (DAS2);
b. a horizontal fork (DAS3) which is attached at its crown to the rear end of down tube (DT) and fork blades at their ends are attached to the circular annular plate (DAS1); wherein outer ring (SOR) of a drive assembly (DA) is fastened to circular annular plate (DAS1).

### Drive Operation

As shown in [FIG. 9], when rotating force is applied on epicyclic ring gear via pedal each planetary gear experiences equal force F along tangential direction at the point of coupling. The top planetary gear which attached to the hub causes wheel to rotate. Gear ratio provided is equal to the ratio of the radius of epicyclic gear ring to the ratio of planetary gear which is normally around 2.5.

### Impact of Rear Wheel Support Mechanism

Angle delta between plane of the rear fork (RWS2) and the rear fork support (RWS1) as shown in [FIG. 10], is less than 90 degree. Let the force acting along the plane of rear fork due to weight W of the rider be denoted by W1. As shown in the [FIG. 10] horizontal component of this force W1 is in the direction of the motion of the bicycle/reverse trike.

1. Ergonomic bilaterally sided chainless compact drive mechanism with localized gear ratio for reverse trike and bicycle protecting rider clothing from gears, comprising of a suitably mounted seat, bilaterally sided compact drive mechanism with localized gear ratio, rear wheel assembly, robust rear wheel support system and drive assembly support system.

2. Chainless compact drive mechanism with localized gear ratio protecting rider clothing from gears, as claimed in [claim 1], comprises a pair of chainless drive assemblies providing gear ratio and a pair of pedals.

3. Rear wheel assembly claimed in [claim 1], consists of wheel with a one way ratchet ball bearing coaxially mounted at each of the ends of its hub integrates the drive assemblies claimed in [claim 2] to the wheel with the help of robust rear wheel support system and drive assembly support system claimed in [claim 1] to provide ergonomic seating arrangement.

4. Each chainless drive assembly providing localized gear ratio, as claimed in [claim 2], comprises of
a special type of epicyclic gear which we refer as pivoted-slewing-bearing-epicyclic-gear, and a pair of pedals.

5. Pivoted-slewing-bearing-epicyclic-gear, as claimed in [claim 4], comprises
a circular plate called as carrier plate having plurality of spur gears including planetary gears, a sun gear, satellite gears and far planet gears journalled to it and connected along its circumference to a internal toothed slewing bearing via U-shaped pegs, in arrangement such that
center of sun gear is at the center of the carrier plate,
carrier plate at its side containing sun gear is attached at its periphery to the outer ring of the said slewing bearing over-bridging gear ring with the help of U-shaped pegs such that slewing bearing is coaxial with Sun gear,
each of planetary gears which are spur gears of equal radii is meshingly engaged with sun gear and gear ring of the slewing bearing,
each satellite gear is meshingly engaged with two adjacent planetary gears and a far planet gear,
each far planet gear is meshingly engaged with gear ring of the said slewing bearing and a satellite gear,
and a pivot plate, which is an eared circular plate with radius equal to the average of outer and inner radius of gear ring, is attached at its rim to the gear ring at its outer side and is coaxially journalled to the outer side of the carrier plate.

6. Pivoted-slewing-bearing-epicyclic gear, described in [claim 5], is constrained to follow the conditions that
number of planetary gears, satellite gears and far planet gears used are three;
radius of planetary gears being greater than the radius of sun gear, satellite gears and far planet gears;
satellite gears are of equal radii;
far planet gears are of equal radii;
centers of three planetary gears forms an equilateral triangle with its circumcenter being center of sun gear;
centers of satellite gears and far planet gears falls on the perpendicular bisectors of the said triangle.

7. Drive assemblies are mounted on the rear wheel with the help of rear wheel support system and drive assembly support system, claimed in [claim 1], such that drive assemblies lies on the front half of the rear wheel allowing placement of rider seat on the front part of rear wheel wherein
one planetary gear of pivoted-slewing-bearing-epicyclic gear, claimed in [claim 5], at its center is connected coaxially to a one way ratchet ball bearing claimed in [claim 3];
other two planetary gear falls on towards the front side at equal distance from rear planetary gear described above.

8. A pedal, claimed in [claim 2] is pivoted to the periphery of the pivot plate, claimed in [claim 5], at its outer side.

9. Rear wheel support system, claimed in [claim 1], which promotes forward motion, comprises a backward slanted fork which is attached at its crown to the rear end of rear wheel support rod and whose fork blades at their ends are attached to outer ring of a ball bearing which in turn is coaxially mounted on the hub of the rear wheel wherein rear wheel support rod is a straight horizontal rod which is attached at its front end to the rear end of top tube as its rearward extension extending reawardly beyond the center of the rear wheel.

10. Drive assembly support system, claimed in [claim 1], located on front half of the rear wheel facilitating placement of rider seat towards the front half of rear wheel comprises
a pair of circular annular plate on two sides of bicycle/reverse trike attached to outer side of the fork blades rear wheel support system claimed in [claim 9], via rods and
a horizontal fork which is attached at its crown to the bottom end of seat tube/down tube and fork blades at their ends are attached to the said circular annular plate wherein outer ring claimed in [claim 5] of a drive assembly is fastened to said circular annular plate.
